(19) United States
(12) Patent Application Publication
(10) Pub. No.: US 2007/0045442 A1
(43) Pub. Date: Mar. 1, 2007

(54) Thermostat display system providing backlight warning

(75) Inventors: John Gilman Chapman JR., Delaware, OH (US); Robert Burt, Columbus, OH (US); Tony Gray, Dublin, OH (US)

Correspondence Address: REINHART BOERNER VAN DEUREN P.C., 2215 PERRYGREEN WAY, ROCKFORD, IL, 61107, US

(73) Assignee: Ranco Incorporated of Delaware, Wilmington, DE (US)

(21) Appl. No.: 11/216,603

(22) Filed: Aug. 31, 2005

(51) Int. Cl. G05D 23/00

(52) U.S. Cl. 236/94

(57) ABSTRACT

A display system for a digital thermostat having a backlit user display screen to indicate user intervention or attention is required is provided. The display system flashes the backlight display in a predetermined pattern to draw the attention of the user to the thermostat. Different patterns may be used for different levels of warnings and/or system reminders. An additional visual indication may also be provided on the user display screen in addition to the flashing of the backlight display. Resumption of normal backlight operation occurs during user interaction. If the issue that resulted in the visual indication has not been properly resolved, flashing of the backlight will resume.

### FIELD OF THE INVENTION

The present invention relates generally to digital thermostats, and more particularly to a display system for a digital thermostat that provides a visual indication that user attention is required.

### BACKGROUND OF THE INVENTION

Occupants of dwellings and commercial structures have long benefited from the inclusion of a heating, ventilating, and air conditioning (HVAC) system that regulates the temperature and humidity within the dwelling or structure. Traditionally, the thermostat that controlled this temperature regulating equipment was a fairly simple electromechanical device that was simply wired to a heating device and/or to a cooling device. Once installed, the user need only move a selector switch between heating and cooling to designate which equipment was desired to be operated, move a selector switch between run and auto for a fan control, and rotate a dial to a desired set point temperature. No other user interface to the thermostat was needed or available, and no indication of system operation was provided.

Advances in control electronics have allowed the development of new, digital thermostats that may be programmed by a user to control the heating and cooling equipment in a much more energy efficient manner than the older electromechanical devices. These modern digital thermostats allow programming that can automatically set back the heat, for example, during periods when the dwelling or structure is not occupied, and can turn up the heat just prior to and during periods of occupation of the dwelling or structure. Indeed, many such digital thermostats allow for different programming options during different days of the week. For example, such a digital thermostat may provide for one programmed operation during the week and a different programmed operation on the weekend, to accommodate the different usage patterns of the occupants of that particular dwelling or structure. Service reminders and other system maintenance information may also be tracked and displayed to ensure that the heating and cooling system runs as efficiently as possible.

Such programming, however, requires that the thermostat be programmed with and keep track of the time of day, day of the week, month, year, etc. so that proper operation and generation of service reminders can be generated at the appropriate time. However, it is possible for the thermostat to lose track of this time information as a result of, for example, extended power outages as may result from storm damage, accidents, or loss of battery power in remote, battery powered devices. In the event that such information is lost, the thermostat needs to draw the consumer's attention to this fact so that the consumer may reprogram the thermostat to allow proper operation of the heating and/or cooling system. Indeed, even if such information is not lost, the provision of the service reminders or indication of erroneous operation detected by the thermostat needs to be conveyed to the user. As such, the thermostat needs to draw the consumer's attention so that this information may be communicated to them.

Unfortunately, when the thermostat requires input from the user or when the thermostat needs to convey information to the user, there is no conventional means, such as a speaker, to draw the users attention to the device. A typical mechanism to draw the user's attention to the thermostat, as is also used in many other embedded devices, is to add a separate indicator on the thermostat that may be flashed to draw the user's attention to the device. This approach is used, for example, by cell phones and other wireless devices. Typically, these devices add a light emitting diode (LED) which blinks when a call or other message is received for which the user's attention is required. Other home control devices also include LEDs which blink when attention is required at the device.

While the inclusion of a separate LED is generally effective to draw a user's attention, such a solution requires an extra component, which tends to increase the cost of the device. Further, since most LEDs are fairly small and give off a limited amount of light, such a solution may not be particularly effective to draw the attention of a user from a different room or across a large room. This problem is particularly acute in the thermostat application because many thermostats are installed in locations that are not particularly frequented by the occupants, and because the occupant is not typically accustomed to interfacing with the thermostat on a regular basis.

There exists, therefore, a need in the art for a display system for a digital thermostat that provides a visual indication that is conspicuous to draw a user's attention to the thermostat, but that does not require the inclusion of a separate, dedicated indicator for such purpose, when user input is required by the thermostat and/or when the thermostat has information that needs to be conveyed to the user.

The invention provides such a digital thermostat display system. These and other advantages of the invention, as well as additional inventive features, will be apparent from the description of the invention provided herein.

### BRIEF SUMMARY OF THE INVENTION

The present invention provides a new and improved digital thermostat. More particularly, the present invention provides a new and improved digital thermostat having a display system that provides a conspicuous visual indication to attract a user's attention to the thermostat when user intervention or input is required and/or when information needs to be conveyed to the user. Even more particularly, the present invention provides such a display system that does not require the installation or inclusion of a dedicated indicator.

In one embodiment of the present invention, a digital thermostat having a user display screen that includes a backlight for illumination of the screen for reading in the dark and lowlight conditions is provided. In accordance with this embodiment, the thermostat blinks this backlight illumination to draw a user's attention to the thermostat when it is determined that user attention or intervention is required and/or when the thermostat has information that needs to be conveyed to the user. Such a backlight is generally much brighter and more visible from a distance than the typical LED indicator, and thus provides a better notification that will draw a user's attention to the device when blinking.

In one embodiment of the present invention, when attention is required at the thermostat, the backlight will blink in a specific pattern. In one embodiment the pattern turns the backlight on for one second and off for nine seconds. In another embodiment of the present invention, the notification pattern blinks the backlight twice at a fast rate, preferably 500 milliseconds, and then remains off for a longer duration. Depending on the reason for the notification and in one embodiment, during the blinking pattern of the backlight, normal operation of the thermostat will be suspended until a user presses the button or interacts with the thermostat. In another embodiment, normal operation will continue unimpeded. Once the user has finished interacting with the thermostat, the backlight will either resume normal operation if the user has properly attended to the issue, or resume a blinking pattern if additional intervention is required.

In an alternate embodiment of the present invention, in addition to the flashing of the backlight illumination, an additional visual indication may be provided on the user display screen of the thermostat. In one embodiment this additional visual indication may take the form of flashing information on the user display screen. For example, flashing the time display if the thermostat has lost the current time of day information, until the information has been re-entered into the thermostat. In one embodiment the flashing of the backlight display ceases while the user is interacting with the thermostat, but will resume if the user fails to address the issue that resulted in the flashing of the backlight. Once the information or other interaction is complete, normal operation and display on the thermostat will resume.

In a further embodiment of the present invention, the backlight pattern itself is used to indicate different levels of attention required. In one embodiment a fast blinking pattern indicates that immediate attention is required for proper operation of the system. A slow pattern is used to indicate a non-critical warning or request for attention, such as a service interval reminder to, e.g., replace the fan filter on the heating and/or cooling system.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a top view illustration of an embodiment of a thermostat constructed in accordance with the teachings of the present invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

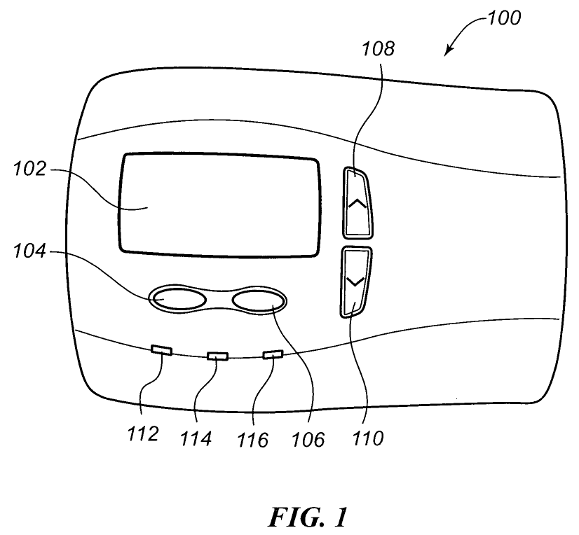

An embodiment of a thermostat constructed in accordance with the teachings of the present invention that incorporates the display system of the present invention is illustrated in FIG. 1. As with many thermostats, an internal temperature sensor that is monitored by the internal processor is included within the thermostat 100. As may be seen from this FIG. 1, this embodiment of the thermostat 100 includes a user display 102 on which is displayed programmatic, system, and ambient information regarding the operation of the HVAC system. This user display 102 may take various forms as are well-known in the art, and in a preferred embodiment is a dot matrix LCD display. The user display screen 102 may be selectively illuminated by backlight illumination, and therefore may be referred to as a backlit user display screen 102. With such a display 102, the consumer may activate various programmatic and control functions via a pair of soft keys 104, 106. The functionality executed by these soft keys 104, 106 varies dependent upon the programmatic state in which the thermostat 100 is at the time one of the soft keys 104, 106 is depressed. The particular functionality that will be instituted upon selection of one of the soft keys 104, 106 is displayed in an area of the user display 102 proximate the key 104, 106 which will institute that function. That is, the function that will be instituted upon selection of soft key 104 will be located generally in the lower left hand portion of user display 102 while the functionality that will be instituted by selection of soft key 106 will be located generally in the lower right hand portion of user display 102. These functional indicators may change depending on the program state and mode in which the thermostat is currently operating.

In addition to the soft keys 104, 106, this embodiment of the thermostat 100 of the present invention also includes adjustment keys 108, 110. These adjustment keys 108, 110 may serve to adjust a currently selected parameter up or down, such as in the case of setting the control temperature at which the thermostat will maintain the ambient environment. Additionally, these keys 108, 110 may scroll through the available data for a selected parameter, such as scrolling through alphanumeric data that may be selected for a given parameter. These keys 108, 110 may also function as soft keys depending on the programmatic state in which the thermostat is operating. When this functionality is provided, the function that will be instituted by selection of key 108 will be provided generally in the upper right hand corner of display 102, while the functionality that will be instituted by selection of key 110 will be displayed generally in the lower right hand comer of user display 102. In addition to the above, other use input means, such as an alphanumeric keypad, user rotatable knob, a touch screen, etc. may be utilized instead of the buttons 104-110 illustrated in the embodiment of FIG. 1.

In one embodiment, the thermostat 100 also includes operating mode visual indicators 112, 114, 116. These indicators 112-116 can be used provide a visual indication of the current operating mode of the thermostat if so desired by the user. If selected for usage be the consumer, indicator 112 will illuminate while the thermostat 100 is operating in the cooling mode. Indicator 116 will illuminate while the thermostat 100 is operating in the heating mode. Finally, indicator 114 will illuminate to indicate that the fan is operating. Depending on the particular application, this indicator 114 may illuminate whenever the fan is running, or may illuminate only when the fan is selected to run continuously.

In embodiments of the present invention that do not utilize automated switching control between the heating and cooling modes of operation, these indicators 112-116 may operate as user selectable switches to allow the consumer to select the operating mode of the thermostat 100. For example, during the summer months the consumer may select the cooling mode by depressing indicator 112. In this mode, the furnace will not be turned on even if the interior ambient temperature drops below the set point. To switch from the cooling to the heating mode of operation, the consumer, in this alternate embodiment, would need to select indicator 116 to allow the thermostat 100 to operate the furnace. Consumer selection in this embodiment of indicator 114 would operate the fan continuously, as opposed to its normal automatic operation based upon a call for cooling or heat by the thermostat 100. In a still further embodiment of the present invention, the indicators 112-116 may also be utilized to provide a visual indication of system trouble, or that there is a system reminder message being displayed on user screen 102.

Having discussed the physical structure of one embodiment of a thermostat 100 constructed in accordance with the teachings of the present invention, the discussion will now focus on the display system which forms an aspect of the present invention. Indeed, while the following discussion will utilize the structure of the thermostat 100 illustrated in FIG. 1, those skilled in the art will recognize that various other structures can be utilized without departing from the spirit and scope of the present invention. That is, regardless of the user input mechanisms utilized by the particular embodiment of the thermostat 100 of the present invention, the programmatic steps and display information provided in the following discussion may be used.

As discussed above, previous embedded devices utilize a separate indicator, such as an LED, to provide a visual notification that user attention is required. Typically such LED indicators were dedicated to that sole purpose, i.e., they serve no other function than to provide the visual indication that user attention is required. However, since the inclusion of such a dedicated LED or other visual indicator increases the cost of the device, its usage is undesirable. Further, while the usage of such a dedicated LED indicator may be effective to draw a user's attention to the embedded device, part of their effectiveness comes from the fact that users are accustomed to interacting with such an embedded device, typically multiple times each day.

In a digital thermostat, however, the usage of such a dedicated visual indicator is not desirable because of the increased cost and the lack of effectiveness of such a dedicated LED indicator. Part of this ineffectiveness may be because the user does not typically expect to interface with the thermostat on a daily basis, and therefore does not typically pay much attention to the thermostat itself. Also, many thermostats are mounted within dwelling in inconspicuous locations where the usage of such a small dedicated LED indicator may also not be noticed.

As illustrated in FIG. 1, an embodiment of the thermostat 100 includes three operating mode visual indicators 112, 114, 116. While in one embodiment these visual indicators may be flashed individually, in sequence, or all together to provide the visual indication of attention being needed, a preferred embodiment of the present invention provides a much more effective visual notification that a user's attention is required by the thermostat.

In a preferred embodiment the backlight of the LCD user display screen 102 is used to provide the visual notification to the user. Unlike the typical LED indicator used in other embedded devices, the backlight of the thermostat 100 is much brighter and more visible from a distance than such an LED indicator light. The blinking or flashing of the backlight of the user display 102 is particularly advantageous for a thermostat because it is typically mounted on a wall with the user display screen 102 facing outward where it is always visible to a user.

Despite the fact that many other embedded devices include a backlit LCD display, such devices have not provided a flashing of the backlight display. Instead, they have included the separate, dedicated LED indicator. The placement of the dedicated LED indicator on such devices is typically on the top or side of the housing of the embedded device where it may be seen by a user regardless of how the embedded device is held by or attached to the consumer, or how the device is laid on a desk or table. Indeed, many such devices, e.g., cell phones, Blackberry devices, etc., are held in a holster that either covers or positions the LCD screen in a protected, non-visible location to the consumer. With such embedded devices it is also fairly typical that they may be set on a desk or table with the LCD screen facing the desk or table, and therefore the screen would not be visible to the consumer. However, since a thermostat is typically permanently affixed to the wall, the LCD screen is always visible. This presents a unique opportunity for usage of the backlight display to provide the visual notification that user attention is required.

In a preferred embodiment of the present invention, the thermostat will blink the backlight of the user display 102 in a specific pattern. While, in one embodiment, the backlight display may simply be turned on when user attention is required, a preferred embodiment of the present invention blinks or otherwise flashes the backlight as such is more effective to attract the user's attention. The blinking pattern in one embodiment illuminates the user display screen's backlighting for one second, and turns it off for nine seconds. In an alternate embodiment, the backlight display is blinked twice at a fast rate, and then is turned off for a longer duration, before the blinking pattern is repeated. In one embodiment the fast rate is approximately 500 milliseconds, and the longer duration period may be between one and ten seconds, and preferably between three and five seconds.

In a further embodiment of the present invention, multiple backlight blinking patterns are used to indicate different levels of interaction required or requested. In such an embodiment a fast pattern of backlight blinking is used to indicate that immediate attention from the user is required. An example of such a situation may be where the thermostat detects or is otherwise notified of erroneous operation of the heating and/or cooling equipment, loss of time information, etc. In this embodiment a slow pattern of backlight blinking is used to indicate a non-critical warning or the provision of other information of a non-critical nature. An example of such information may be the provision of a service interval reminder, e.g., to replace a fan filter on the heating and/or cooling equipment, etc.

Depending on the cause of the situation that requires user attention, and in one embodiment of the present invention, normal operation of the thermostat will be halted during the blinking pattern of the backlight display. Such suspended operation will continue until a user presses a button or otherwise interacts with the thermostat. After the user has finished interacting with the thermostat, the backlight will either resume normal operation if the user has fixed the issue that caused the backlight flashing, or the backlight will resume the blinking pattern if the issue has not been completed or resolved by the user interaction. When the backlight blinking has been initiated for a non-critical reason, for example, a provision of a service internal reminder, and in one embodiment, the blinking of the backlight display does not suspend normal operation of the thermostat. This is because the provision of such information to the user does not affect the safe and/or programmed operation of the heating and/or cooling equipment.

In one embodiment of the present invention, an additional visual indication may also be provided. This additional visual indication includes flashing of the information on the LCD display. One such example of this additional visual indication may be provided, e.g., by flashing the time display if the time information has been lost. This additional visual indication may continue during the period of user interaction, even when the backlight display has stopped its blinking pattern, until the required information has been entered. In the example where the time information has been lost, once the user begins to enter the new time information the blinking of the backlight will be halted, however the hour and minute display on the LCD will continue to flash until the user has entered information for both of these parameters. This will provide a visual confirmation to the user that all of the required fields have been completed before the user ceases interaction with the thermostat. In one embodiment, during the period of interaction, the backlight will remain illuminated even if the additional visual indication continues to flash or blink.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A thermostat for controlling heating and/or cooling equipment, comprising:
a backlit user display screen for displaying operational information about the heating and/or cooling equipment controlled by the thermostat; and
wherein the thermostat blinks illumination of the user display when user attention is desired.

2. The thermostat of claim 1, wherein the thermostat blinks the backlit user display in accordance with a first pattern.

3. The thermostat of claim 2, wherein the first pattern provides illumination of the backlit user display for a first duration and removes illumination of the backlit user display for a second duration longer than the first duration.

4. The thermostat of claim 3, wherein the first duration is approximately one second and the second duration is approximately nine seconds.

5. The thermostat of claim 2, wherein the first pattern provides illumination of the backlit user display for a first duration, removes illumination of the backlit user display for the first duration, provides illumination of the backlit user display for the first duration, and removes illumination of the backlit user display for a second duration longer than the first duration.

6. The thermostat of claim 5, wherein the first duration is approximately 500 milliseconds and wherein the second duration is between approximately one and ten seconds.

7. The thermostat of claim 1, wherein the thermostat blinks the backlit user display in accordance with a first pattern to indicate that immediate attention is required and in accordance with a second pattern to indicate that attention is requested.

8. The thermostat of claim 7, wherein the first pattern is repeated at a first rate and wherein the second pattern is repeated at a second rate slower than the first rate.

9. The thermostat of claim 1, wherein the thermostat provides constant illumination of the backlit user display during user interaction.

10. The thermostat of claim 9, wherein the thermostat resumes normal operation of the backlit user display after the user interaction if a reason for user attention being desired is resolved, and wherein the thermostat resumes blinking of the backlit user display after user interaction if the reason for user attention being desired is not resolved.

11. The thermostat of claim 1, wherein the thermostat provides an additional visual indication on the user display screen.

12. The thermostat of claim 11, wherein the thermostat provides the additional visual indication by blinking information that needs to be addressed by a user.

13. A method of attracting attention to a device having a backlit user display screen on which information may be displayed, comprising the step of blinking illumination of the backlit user display screen.

14. The method of claim 13, wherein the step of blinking the illumination of the backlit user display screen comprises the steps of the illuminating the backlit user display screen for a first duration and removing illumination of the backlit user display for a second duration longer than the first duration.

15. The method of claim 13, wherein the step of blinking the illumination of the backlit user display screen comprises the steps of illuminating the backlit user display for a first duration, removing illumination of the backlit user display for the first duration, illuminating the backlit user display for the first duration, and removing illumination of the backlit user display for a second duration longer than the first duration.

16. The method of claim 13, wherein the step of blinking illumination of the backlit user display screen comprises the step of blinking illumination of the backlit user display screen in accordance with a first pattern to indicate that immediate attention is required, and blinking illumination of the backlit user display screen in accordance with a second pattern to indicate that attention is requested.

17. The method of claim 13, wherein the step of blinking illumination of the backlit user display screen comprises the step of blinking illumination of the backlit user display screen at a first rate to indicate that immediate attention is required, and blinking illumination of the backlit user display screen at a second rate to indicate that attention is requested.

18. The method of claim 13, further comprising the steps of receiving user input in response to the step of blinking, and illuminating the backlit user display screen during the step of receiving user input.

19. The method of claim 18, further comprising the steps of turning off the illumination of the backlit user display screen after the step of receiving user input when attention is no longer needed, and blinking the illumination of the backlit user display screen after the step of receiving user input when attention is still needed.

20. The method of claim 13, further comprising the step of blinking information displayed on the backlit user display screen.
